(19) United States
(12) Patent Application Publication
(10) Pub. No.: US 2022/0376571 A1
(43) Pub. Date: Nov. 24, 2022

(54) ROTARY MOTOR, ROBOT, AND MANUFACTURING METHOD FOR ROTARY MOTOR

(71) Applicant: SEIKO EPSON CORPORATION, Tokyo (JP)

(72) Inventor: Michio SATO, OKAYA-SHI (JP)

(21) Appl. No.: 17/747,002

(22) Filed: May 18, 2022

(30) Foreign Application Priority Data
May 19, 2021 (JP) 2021-084496

(51) Int. Cl. H02K 1/2783; H02K 15/03

(52) U.S. Cl. CPC H02K 1/2783; H02K 15/03

(57) ABSTRACT

A rotary motor includes a stator having a coil, and a rotor placed apart from the stator and rotating around a rotation shaft, wherein the rotor has a rotor frame coupled to the rotation shaft, and a magnet placed on the rotor frame, when a direction from the magnet to the coil is a first direction, the magnet has a plurality of first magnets having anisotropy and magnetized at least in the first direction, and a second magnet having isotropy and placed on end surfaces of the first magnets at a positive side in the first direction.

The present application is based on, and claims priority from JP Application Serial Number 2021-084496, filed May 19, 2021, the disclosure of which is hereby incorporated by reference herein in its entirety.

### BACKGROUND

### 1. Technical Field

The present disclosure relates to a rotary motor, a robot including a rotary motor, and a manufacturing method for a rotary motor.

### 2. Related Art

In a permanent magnet motor of JP-A-2004-15906, a radial gap motor in a Halbach magnet array including main permanent magnets having a magnetization direction in a radial direction and auxiliary permanent magnets having a magnetization direction in a circumferential direction is disclosed.

However, in JP-A-2004-15906, a plurality of anisotropic magnets having different magnetization directions are combined, and a magnetic flux density distribution tends to depart from sinusoidal wave at a boundary between the main permanent magnet and the auxiliary permanent magnet. As a result, there is a problem that cogging torque tends to be generated.

### SUMMARY

A rotary motor includes a stator having a coil, and a rotor placed apart from the stator and rotating around a rotation shaft, wherein the rotor has a rotor frame coupled to the rotation shaft, and a magnet placed on the rotor frame, when a direction from the magnet to the coil is a first direction, the magnet has a plurality of first magnets having anisotropy and magnetized at least in the first direction, and a second magnet having isotropy and placed on end surfaces of the first magnets at a positive side in the first direction.

A robot includes the above described rotary motor and a driven member driven by the rotary motor.

A manufacturing method for a rotary motor is a manufacturing method for a rotary motor having a stator having a coil, a rotor rotating around a rotation shaft, a rotor frame coupled to the rotation shaft, and a magnet having an anisotropic magnet and an isotropic magnet, and the method includes an anisotropic magnet placement step of placing the unmagnetized anisotropic magnet on the rotor frame, when a direction from the anisotropic magnet to the coil is a first direction, an isotropic magnet placement step of placing the unmagnetized isotropic magnet on an end surface of the anisotropic magnet at a positive side in the first direction, a magnetization step of magnetizing the placed unmagnetized anisotropic magnet and isotropic magnet, and a stator placement step of placing the stator in the first direction with respect to the rotor in which the magnetized anisotropic magnet and isotropic magnet are placed.

### BRIEF DESCRIPTION OF THE DRAWINGS

FIG. 1 is a sectional view showing a schematic configuration of a rotary motor according to a first embodiment.

FIG. 2 is a perspective view showing a configuration of a magnet.

FIG. 3 is a partially sectional view when a rotor is cut along a surface orthogonal to a radial direction.

FIG. 4 is a flowchart for explanation of a manufacturing method for the rotary motor.

FIG. 5 is a sectional view showing a configuration of a magnet of a rotary motor according to a second embodiment.

FIG. 6 is a sectional view showing a configuration of a magnet of a rotary motor according to a third embodiment.

FIG. 7 is a sectional view showing a configuration of a magnet of a rotary motor according to a fourth embodiment.

FIG. 8 is a sectional view showing a configuration of a magnet of a rotary motor according to a fifth embodiment.

FIG. 9 is a sectional view showing a configuration of a magnet of a rotary motor according to a sixth embodiment.

FIG. 10 is a sectional view showing a configuration of a magnet of a rotary motor according to a seventh embodiment.

FIG. 11 is a sectional view showing a configuration of a magnet of a rotary motor according to an eighth embodiment.

FIG. 12 is a sectional view showing a configuration of a magnet of a rotary motor according to a ninth embodiment.

FIG. 13 is a schematic perspective view showing a configuration of a rotary motor according to a tenth embodiment.

FIG. 14 is a schematic plan view showing the configuration of the rotary motor.

FIG. 15 is a schematic plan view showing a configuration of a rotary motor according to an eleventh embodiment.

FIG. 16 is a schematic plan view showing a configuration of a rotary motor according to a twelfth embodiment.

FIG. 17 is a perspective view showing a configuration of a robot according to a thirteenth embodiment.

FIG. 18 shows a simplified configuration of the robot.

### DESCRIPTION OF EXEMPLARY EMBODIMENTS

As below, embodiments for implementing the present disclosure will be explained with reference to the drawings. In the respective drawings, dimensions and scales of the respective parts will be appropriately made different from real ones.

### 1. First Embodiment

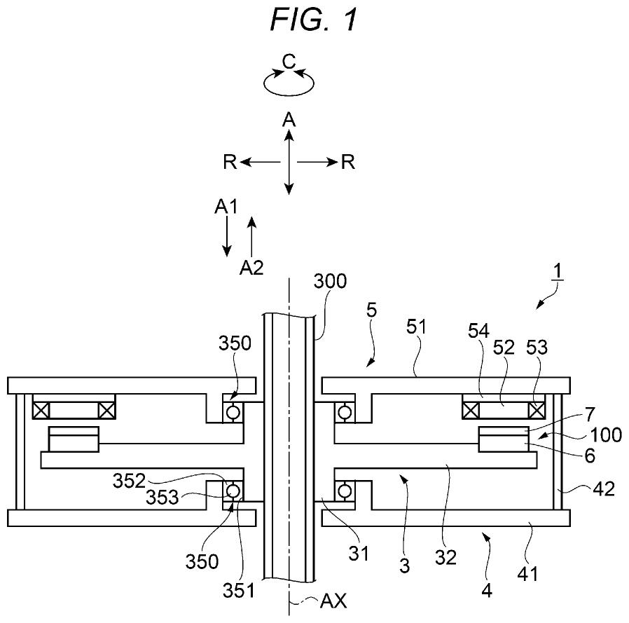

FIG. 1 is a sectional view showing a schematic configuration of a rotary motor 1 according to a first embodiment. In FIG. 1, the rotary motor 1 is formed as an axial gap motor.

The axial gap motor is a motor having a gap between a magnet 100 and a coil 53 in an axial direction A of a rotation shaft 300, which will be described later. As shown in FIG. 1, the rotary motor 1 is a motor employing the so-called 1-rotor 1-stator structure.

Specifically, as shown in FIG. 1, the rotary motor 1 includes a rotor 3 having an annular shape and rotating around the rotation shaft 300, a stator 5 placed at the upside of the rotor 3 (specifically, a rotor frame 32) along the rotation shaft 300, and a case 4 placed at the downside.

In the following description, directions along a center axis AX of the rotation shaft 300 are referred to as “axial directions A” or “upward and downward directions”, circumferential directions of the rotor 3 are referred to as “circumferential directions C”, and a radial direction of the rotor 3 is referred to as “radial direction R”. Further, particularly, a direction from the stator 5 to the case 4 is referred to as “downward direction A1” and a direction from the case 4 toward the stator 5 is referred to as “upward direction A2”.

The rotation shaft 300 is a hollow cylindrical member. Note that the rotation shaft 300 may be a solid cylindrical member. In the rotary motor 1 of the embodiment, the rotation shaft 300 is made larger in the radial direction and formed as a hollow shaft, and wires to the rotary motor 1 are passed through the hollow part of the rotation shaft 300.

The rotor 3 includes a rotor fixing portion 31 fixed to the rotation shaft 300, the rotor frame 32 extending from the rotor fixing portion 31 in the radial direction and forming a disc shape, and the magnet 100 as a permanent magnet supported by the rotor frame 32. The magnet 100 is placed along the circumferential directions C near the end of the rotor frame 32 in the radial direction R. The rotor 3 will be described in detail later.

The stator 5 is placed via a gap in the upward direction A2 of the rotor frame 32. The stator 5 has a top case 51 having an annular shape, a plurality of stator cores 52, coils 53 placed in the respective stator cores 52, and a back yoke 54 coupling the plurality of stator cores 52. The stator cores 52 and the back yoke 54 are placed in the downward direction A1 of the top case 51 and the back yoke 54 is fixed to the top case 51.

The top case 51 is formed using e.g. a non-magnetic material including austenite stainless steel. Alternatively, the top case may be formed using various magnetic materials including a multilayered structure of magnetic steel sheets and a green compact of magnetic powder, particularly, using a soft magnetic material of the magnetic materials. Note that the top case 51 may be formed by assembly of a plurality of parts.

As described above, the stator 5 has the plurality of stator cores 52 and the back yoke 54. The back yoke 54 is a member having an annular shape along the circumferential directions C. The stator core 52 projects from the back yoke 54 along the downward direction A1. Further, the stator cores 52 are arranged at equal intervals to face the magnet 100 at a predetermined distance along the circumferential directions C. The respective stator cores 52 and the back yoke 54 are formed using e.g. various magnetic materials including multilayered structures of magnetic steel sheets and green compacts of magnetic powder, particularly, using soft magnetic materials of the magnetic materials.

The back yoke 54 may be fixed to the top case 51 by e.g. melting, adhesive, welding, or the like, or engaged with the top case 51 using various engagement structures.

The coil 53 is wound around the outer circumference of the stator core 52. The stator core 52 and the coil 53 form an electromagnet. The coil 53 may be a conducting wire wound around the stator core 52 or a conducting wire may be wound around a bobbin or the like in advance and fitted around the outer circumference of the stator core 52.

The rotary motor 1 has an energizing circuit (not shown). Each coil 53 is coupled to the energizing circuit. Each coil 53 is energized in a predetermined cycle or predetermined pattern. For example, if a three-phase alternating current is applied to each coil 53, a magnetic flux is generated from the electromagnet and a magnetic force acts on the facing magnet 100. The state is cyclically repeated, and thereby, the rotor 3 rotates around the rotation shaft 300.

The case 4 is formed similarly to the stator 5 with the rotor 3 in between. Note that the case 4 includes a bottom case 41 having an annular shape corresponding to the top case 51. The case 4 does not have an electromagnet like that of the stator 5. The case 4 includes a center case 42 coupling the bottom case 41 and the top case 51. The center case 42 is located outside of the rotor 3 and has a cylindrical shape. Note that the case 4 may be formed using a resin member as a whole.

The bottom case 41 of the case 4 and the rotor fixing portion 31 of the rotor 3 are coupled via a ball bearing 350. The top case 51 of the stator 5 and the rotor fixing portion 31 of the rotor 3 are coupled via a ball bearing 350. The operations of the ball bearings 350 are the same and, as below, the operation of the ball bearing 350 in the downward direction A1 will be representatively explained.

The ball bearing 350 includes an inner ring 351, an outer ring 352, and a rolling member 353. The bottom case 41 is coupled to the outer ring 352 and the rotor fixing portion 31 is coupled to the inner ring 351. The inner ring 351 and the outer ring 352 rotate with each other via the rolling member 353. Thereby, the rotor 3 is rotatably supported relative to the stator 5 and the case 4. Note that the ball bearing 350 may be replaced by another type of bearing.

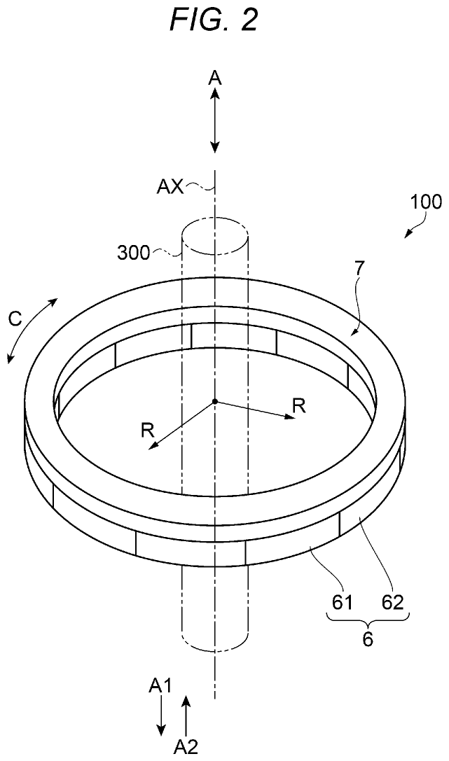

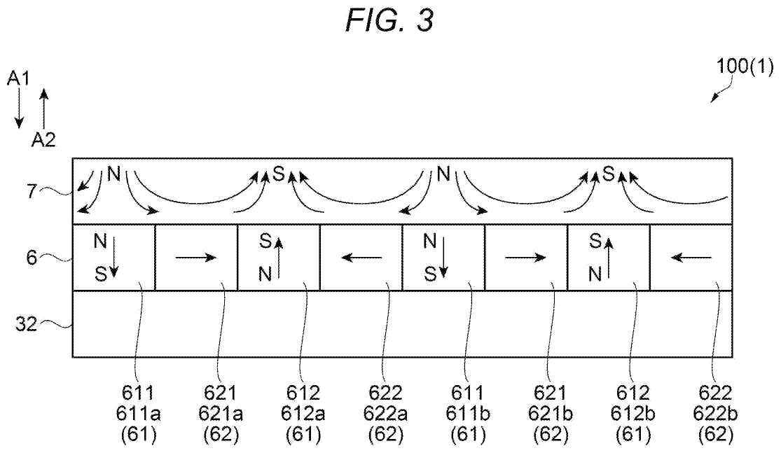

FIG. 2 is a perspective view showing a configuration of the magnet 100. FIG. 3 is a partially sectional view when the rotor 3 is cut along a surface orthogonal to the radial direction R. Arrows shown in a first magnet 6 in FIG. 3 schematically show directions of magnet poles of the first magnet 6. Further, arrows shown in a second magnet 7 in FIG. 3 schematically show directions of lines of magnetic flux of the second magnet 7.

As shown in FIGS. 2 and 3, the magnet 100 has the first magnet 6 having anisotropy and the second magnet 7 having isotropy. Here, a direction from the magnet 100 toward the coil 53 shown in FIG. 1 is referred to as “first direction”. In the embodiment, the first direction corresponds to the upward direction A2. The second magnet 7 is placed on an end surface of the first magnet 6 at the positive side in the first direction (upward direction A2).

In the embodiment, the positive side corresponds to the coil 53 side. The description that the second magnet 7 placed on the end surface of the first magnet 6 at the positive side in the first direction (upward direction A2) includes a case where the first magnet 6 and the second magnet 7 are bonded and a case where the magnets are not bonded. In the embodiment, the first magnet 6 and the second magnet 7 are bonded and fixed.

The first magnet 6 has main pole magnets 61 and sub-pole magnets 62. The first magnet 6 is formed in an annular shape by combination of the main pole magnets 61 and the sub-pole magnets 62 adjacent to the main pole magnets 61. Specifically, in the first magnet 6, the main pole magnets 61 and the sub-pole magnets 62 are alternately arranged at predetermined pitches along the circumferential directions C. The main pole magnets 61 and the sub-pole magnets 62 are arranged in the so-called Halbach array.

The first magnet 6 (main pole magnets 61 and sub-pole magnets 62) of the embodiment is an Nd—Fe—B sintered magnet and has anisotropy by compression molding of a powdery magnetic material with application of a magnetic field. Further, the first magnet 6 of the embodiment has parallel anisotropy. The second magnet 7 of the embodiment is a ferrite sintered magnet. The second magnet 7 has isotropy by compression molding of a powdery magnetic material without application of a magnetic field.

The anisotropic magnet refers to a magnet magnetized only in a single direction. Not only the parallel anisotropic magnet but also a radial anisotropic magnet magnetized in the radial direction may be used. In the embodiment, the parallel anisotropic magnet is used.

The array of the first magnet 6 of the embodiment will be explained in detail.

As shown in FIG. 3, for the main pole magnets 61, magnets magnetized in two directions of the upward and downward directions (axial directions A) are used. The main pole magnet 61 has first main pole magnets 611 magnetized in the downward direction A1 and second main pole magnets 612 magnetized in the upward direction A2. For the sub-pole magnets 62, magnets magnetized in two directions of the circumferential directions Care used. The sub-pole magnet 62 has first sub-pole magnets 621 magnetized toward the right side in the circumferential directions C and second sub-pole magnets 622 magnetized toward the left side in the circumferential directions C.

Specifically, as shown in FIG. 3, the first main pole magnet 611 (referred to as “first main pole magnet 611a”) located at the leftmost side on the paper surface has an N-pole in the upward direction A2 and an S-pole in the downward direction A1. The second main pole magnet 612 (referred to as “second main pole magnet 612a”) with the first sub-pole magnet 621 (referred to as “first sub-pole magnet 621a”) in the rightward direction from the first main pole magnet 611a has an N-pole in the downward direction A1 and an S-pole in the upward direction A2. The first sub-pole magnet 621a is placed between the first main pole magnet 611a on the left side and the second main pole magnet 612a on the right side and magnetized from the first main pole magnet 611a toward the second main pole magnet 612a .

Further, the first main pole magnet 611 (referred to as “first main pole magnet 611b”) is placed again with the second sub-pole magnet 622 (referred to as “second sub-pole magnet 622a”) in the rightward direction from the second main pole magnet 612a . The second sub-pole magnet 622 (referred to as “second sub-pole magnet 622a”) is placed between the second main pole magnet 612a on the left side and the first main pole magnet 611b on the right side and magnetized from the first main pole magnet 611b toward the second main pole magnet 612a . In the embodiment, the main pole magnets 61 and the sub-pole magnets 62 are repeatedly placed in the above described arrangement. In FIG. 3, on the right side of the first main pole magnet 611b , the first sub-pole magnet 621b , the second main pole magnet 612b , and the second sub-pole magnet 622b are sequentially arranged.

As shown in FIG. 3, a magnetic flux flows from the leftmost side on the paper surface sequentially to the first main pole magnet 611a , the first sub-pole magnet 621a , and the second main pole magnet 612a . In the next arrangement, a magnetic flux flows sequentially to the first main pole magnet 611b , the second sub-pole magnet 622a , and the second main pole magnet 612a . Those flows of magnetic flux are repeated.

In the embodiment, the second magnet 7 is placed to face the upper surface of the above described first magnet 6. As described above, the second magnet 7 is integrally formed in an annular shape. Further, the lower surface of the second magnet 7 and the upper surface of the first magnet 6 (main pole magnets 61 and sub-pole magnets 62) are bonded and fixed by an adhesive agent or the like. In the above described main pole magnets 61 and sub-pole magnets 62, the magnets are bonded to each other and fixed by an adhesive agent or the like. Furthermore, the first magnet 6 and the rotor frame 32 located at the downside are bonded to each other and fixed by an adhesive agent or the like.

In the embodiment, as shown in FIG. 3, the second magnet 7 is magnetized as the N-poles in the upper parts of the first main pole magnets 611 and magnetized as the S-poles in the upper parts of the second main pole magnets 612. The second magnet 7 is magnetized repeatedly as the N-poles and the S-poles as described above.

Therefore, a magnetic flux flows from the leftmost side on the paper surface from the N-pole of the second magnet 7 sequentially to the first main pole magnet 611a , the first sub-pole magnet 621a , and the second main pole magnet 612a of the first magnet 6 at the downside and flows from the S-pole of the second magnet 7 to a space in the gap between the coil in the upward direction and itself. Note that the magnetic flux from the N-pole of the second magnet 7 also flows to the S-pole of the second magnet 7 at the right side.

Further, in the next arrangement, a magnetic flux flows from the N-pole of the second magnet 7 located in the upper part of the first main pole magnet 611b sequentially to the first main pole magnet 611b , the second sub-pole magnet 622a , and the second main pole magnet 612a and flows from the S-pole of the second magnet 7 to a space in the gap between the coil in the upward direction and itself. Note that the magnetic flux from the N-pole of the second magnet 7 also flows to the S-pole of the second magnet 7 at the left side. Those flows of magnetic flux are repeated.

Specifically, the magnetic flux divisionally flows leftward and rightward from the N-pole of the second magnet 7 at the leftmost side on the paper surface like that in the first main pole magnet 611a in the lower part. The magnetic flux from the N-pole of the second magnet 7 at the leftmost side on the paper surface divisionally flows toward the S-pole on the left side and the S-pole on the right side of the second magnet 7. The magnetic flux flowing in the first main pole magnet 611a divisionally flows to the second sub-pole magnet (not shown) on the left side and the first sub-pole magnet 621a on the right side.

In the second main pole magnet 612a , the magnetic fluxes flowing from the first sub-pole magnet 621a and the second sub-pole magnet 622a on the left and right sides collect and flow to the S-pole of the second magnet 7 located in the upper part. Further, at the S-pole of the second magnet 7, the magnetic fluxes flowing from the N-poles of the second magnet 7 at the left and right sides collect and flow to a space in the gap between the coil in the upward direction and itself.

According to the arrangement using the main pole magnets 61 and the sub-pole magnets 62 of the first magnet 6, at the boundary at which the main pole magnet 61 and the sub-pole magnet 62 are coupled, the magnetic flux density distribution is not smooth and the magnetic flux density distribution tends to depart from sinusoidal wave. However, in the embodiment, the second magnet 7 is placed on the end surface of the first magnet 6 at the positive side in the first direction (upward direction A2). Further, the N-poles and the S-poles of the second magnet 7 correspond to the poles of the first main pole magnets 611 and the second main pole magnets 612. Thereby, the magnetic flux density distribution may be made smooth at the boundaries between the main pole magnets 61 and the sub-pole magnets 62 of the first magnet 6, and the magnetic flux density distribution may be made closer to sinusoidal wave. According to the configuration, generation of cogging torque may be suppressed. Further, suppression of cogging by the magnetic flux density distribution closer to sinusoidal wave using the second magnet 7 having isotropy and improvement of magnetic flux density by the plurality of first magnets 6 having anisotropy may be balanced.

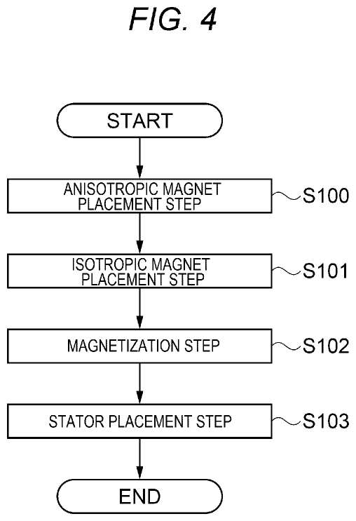

FIG. 4 is a flowchart for explanation of a manufacturing method for the rotary motor 1.

As below, the manufacturing method for the rotary motor 1 will be explained with reference to FIG. 4.

First, an anisotropic magnet placement step (step S100) is performed. Specifically, an unmagnetized anisotropic magnet (unmagnetized first magnet 6) is placed and fixed onto the rotor frame 32. When a direction from the anisotropic magnet toward the coil 53 is a first direction, then, an isotropic magnet placement step (step S101) is performed. Specifically, an unmagnetized isotropic magnet (unmagnetized second magnet 7) is placed and fixed onto an end surface of the anisotropic magnet at the positive side in the first direction. The two steps are to place the unmagnetized first magnet 6 and to place the unmagnetized second magnet 7 on the upper end surface thereof. Almost no magnetic force is generated in the first magnet 6 and the second magnet 7 because the magnets are unmagnetized, and the first magnet 6 and the second magnet 7 do not attract each other and the placement work is easy.

Next, a magnetization step (step S102) is performed. Specifically, a magnetizing yoke (not shown) that generates magnetic fields is routed around the unmagnetized isotropic magnet (unmagnetized second magnet 7) and the unmagnetized anisotropic magnet (unmagnetized first magnet 6) in consideration of the pole directions to be magnetized. Then, a current is flown in the magnetizing yoke. In the embodiment, the unmagnetized isotropic magnet (unmagnetized second magnet 7) and the unmagnetized anisotropic magnet (unmagnetized first magnet 6) are magnetized at a time.

Specifically, the magnetic fields are applied in the upward and downward directions (axial directions A) to the main pole magnets 61 of the first magnet 6 and regions of the second magnet 7 in the upper parts. Thereby, the main pole magnets 61 and the regions of the second magnet 7 in the upper parts are magnetized and, as shown in FIG. 3, the main pole magnets 61 and the regions of the second magnet 7 located in the upper parts having poles are obtained. Therefore, the regions of the second magnet 7 located in the upper parts of the main pole magnets 61 are magnetized along the first direction, in this case, the upward and downward directions. With the application of the magnetic fields in the upward and downward directions, magnetic fields are applied in lateral directions different from the upward and downward directions to the sub-pole magnets 62 of the first magnet band the regions of the second magnet 7 in the upper parts. Thereby, the sub-pole magnets 62 and the regions of the second magnet 7 located in the upper parts are magnetized and the sub-pole magnets 62 and the regions of the second magnet 7 located in the upper parts having poles in directions parallel to the circumferential directions C are obtained. As described above, the unmagnetized isotropic magnet (unmagnetized second magnet 7) and the unmagnetized anisotropic magnet (unmagnetized first magnet 6) are magnetized at a time, and thereby, magnetization is made efficient. Note that the above described magnetic fields applied in the upward and downward directions and magnetic fields applied in the lateral directions may be linear or curved magnetic fields. In the above described magnetization steps, the magnetic fields in the upward and downward directions and the magnetic fields in the lateral directions are applied at a time for efficiency of the magnetization, however, the application may be divided into a plurality of times.

Next, a stator placement step (step S103) is performed. Specifically, the stator 5 is placed in the first direction (upward direction A2) with respect to the rotor frame 32 (rotor 3) on which the magnetized anisotropic magnet (first magnet 6) and isotropic magnet (second magnet 7) are placed. Note that the stator cores 52 with the coils 53 attached thereto are placed in the stator 5.

According to the above described flowchart, the rotary motor 1 is manufactured.

According to the embodiment, the following effects may be obtained.

The rotary motor 1 of the embodiment includes the stator 5, and the rotor 3 rotating around the rotation shaft 300, and the rotor 3 has the rotor frame 32 coupled to the rotation shaft 300 and the magnet 100 placed on the rotor frame 32. Here, when the direction from the magnet 100 toward the coil 53 is the first direction (upward direction A2), the magnet 100 has the plurality of first magnets 6 having anisotropy and magnetized at least in the first direction and the second magnet 7 having isotropy and placed on the end surfaces of the first magnets 6 at the positive side in the first direction.

According to the configuration, the magnetic flux density may be improved by the plurality of first magnets 6 having anisotropy and magnetized at least in the first direction. Further, the second magnet 7 having isotropy is placed on the end surfaces of the first magnets 6 at the positive side in the first direction, and thereby, the magnetic flux density distribution at the boundaries between the first magnets 6 may be made smooth, the magnetic flux density distribution may be made closer to sinusoidal wave, and generation of cogging torque may be suppressed.

In the rotary motor 1 of the embodiment, the first magnet 6 is arranged in a Halbach array having the main pole magnets 61 and the sub-pole magnets 62.

According to the configuration, magnetic characteristics (torque etc.) may be improved compared to an NS array.

In the rotary motor 1 of the embodiment, the second magnet 7 is formed in the annular shape.

According to the configuration, surface accuracy of the second magnet 7 may be increased and the gap between the first magnets 6 and itself may be made smaller. Therefore, the magnetic flux density distribution may be made closer to sinusoidal wave.

In the rotary motor 1 of the embodiment, the regions of the second magnet 7 located in the upper parts of the main pole magnets 61 are magnetized along the first direction.

According to the configuration, in the regions of the second magnet 7 located in the upper parts of the main pole magnets 61, the magnetic fluxes flow in opposite directions to each other, and crossing of the magnetic fluxes may be suppressed. Therefore, reduction of the magnetic flux density may be suppressed.

In the manufacturing method for the rotary motor 1 of the embodiment, the anisotropic magnet placement step, the isotropic magnet placement step, the magnetization step, and the stator placement step are provided. At the magnetization step, the unmagnetized isotropic magnet (unmagnetized second magnet 7) and the unmagnetized anisotropic magnet (unmagnetized first magnet 6) are magnetized at a time. Thereby, the magnetization may be made efficient. Further, when the rotary motor 1 is manufactured, the respective steps are executed, and thereby, the placement and the magnetization may be efficiently performed.

### 2. Second Embodiment

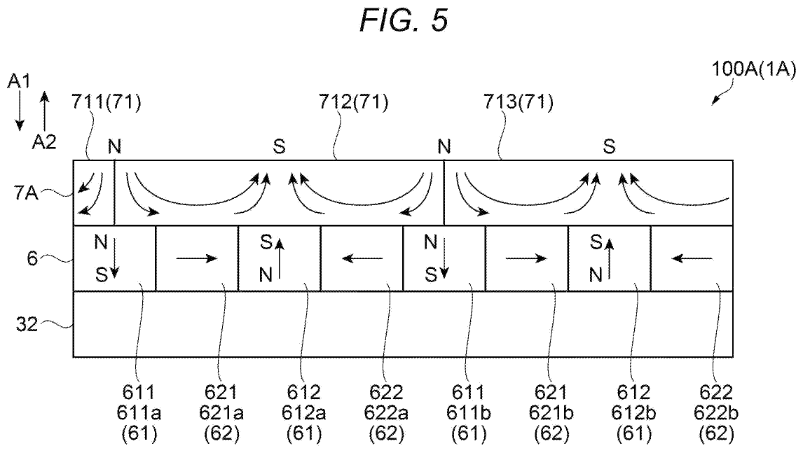

FIG. 5 is a sectional view showing a configuration of a magnet 100A of a rotary motor 1A according to a second embodiment.

The magnet 100A in the rotary motor 1A of the embodiment includes the first magnet 6 of the first embodiment and a second magnet 7A different in form from that of the first embodiment. The other configurations are the same as those of the first embodiment. The same configurations have the same signs.

Specifically, the first magnet 6 of the embodiment is arranged in the same array as that of the first embodiment. The difference is that the second magnet 7A of the embodiment includes a plurality of divided arc-shaped magnets 71. Regarding the second magnet 7A, end surfaces formed by division into the arc shapes are located in regions located in the upper parts of the first main pole magnets 611 of the first magnet 6.

In FIG. 5, the plurality of divided arc-shaped magnets 71 of the second magnet 7A include a first arc-shaped magnet 711, a second arc-shaped magnet 712, and a third arc-shaped magnet 713 from the leftmost side on the paper surface. The number of division of the second magnet 7A is determined by the number of the first main pole magnets 611. Note that the end surfaces in the divided first arc-shaped magnet 711, second arc-shaped magnet 712, and third arc-shaped magnet 713 are magnetized along the first direction as shown in FIG. 5.

The flows of magnetic flux in the divided arc-shaped magnets 71 of the second magnet 7A (first arc-shaped magnet 711, second arc-shaped magnet 712, and third arc-shaped magnet 713) are the same as the flows of magnetic flux in the first embodiment.

According to the embodiment, the following effects may be obtained.

In the rotary motor 1A of the embodiment, the second magnet 7A includes the plurality of divided arc-shaped magnets 71 (first arc-shaped magnet 711, second arc-shaped magnet 712, and third arc-shaped magnet 713).

According to the configuration, compared to the case where the second magnet 7 of the first embodiment is integrally formed in the annular shape, the second magnet 7A is formed as the plurality of divided arc-shaped magnets 71, and the manufacture thereof may be easier.

In the rotary motor 1A of the embodiment, the end surfaces of the plurality of divided arc-shaped magnets 71 (first arc-shaped magnet 711, second arc-shaped magnet 712, and third arc-shaped magnet 713) are located in the upper parts of the main pole magnets 61 (first main pole magnets 611) and magnetized along the first direction.

According to the configuration, the magnetic fluxes flow in the opposite directions to each other on the end surfaces of the arc-shaped magnets 71 (first arc-shaped magnet 711, second arc-shaped magnet 712, and third arc-shaped magnet 713) located in the upper parts of the main pole magnets 61 (first main pole magnets 611). Therefore, even when the second magnet 7A is formed by the plurality of divided arc-shaped magnets 71, crossing of the magnetic fluxes may be suppressed and reduction of magnetic flux density may be suppressed.

### 3. Third Embodiment

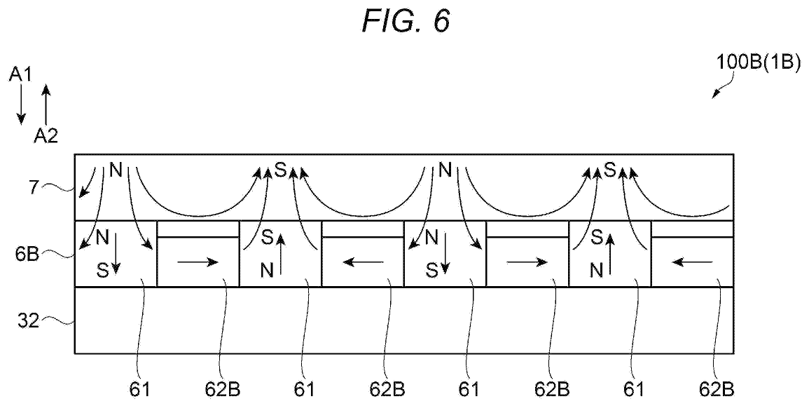

FIG. 6 is a sectional view showing a configuration of a magnet 100B of a rotary motor 1B according to a third embodiment.

The magnet 100B in the rotary motor 1B of the embodiment includes a first magnet 6B different in form from that of the first embodiment and the same second magnet 7 as that of the first embodiment. The other configurations are the same as those of the first embodiment. The same configurations have the same signs.

Specifically, as shown in FIG. 6, the first magnet 6B of the embodiment is arranged in an array of main pole magnets 61 and sub-pole magnets 62B like that of the first embodiment. The difference is that the heights of the upper parts of the sub-pole magnets 62B of the embodiment are formed to be lower than the heights of the adjacent main pole magnets 61. Accordingly, spaces are formed between the sub-pole magnets 62B of the first magnet 6B and the second magnet 7 and the magnets are separated. Further, the main pole magnets 61 of the first magnet 6B and the second magnet 7 contact and may be closely attached and fixed.

According to the configuration, the following effects may be obtained.

In the rotary motor 1B of the embodiment, the main pole magnets 61 of the first magnet 6B and the second magnet 7 contact and the sub-pole magnets 62B of the first magnet 6B and the second magnet 7 are separated.

According to the configuration, the main pole magnets 61 and the second magnet 7 are easily closely attached. That is, the gaps become smaller and magneto resistance generated by the gaps may be reduced. The magnetic flux easily flows in the direction from the second magnet 7 to the main pole magnets 61, and the magnetic flux density may be improved.

### 4. Fourth Embodiment

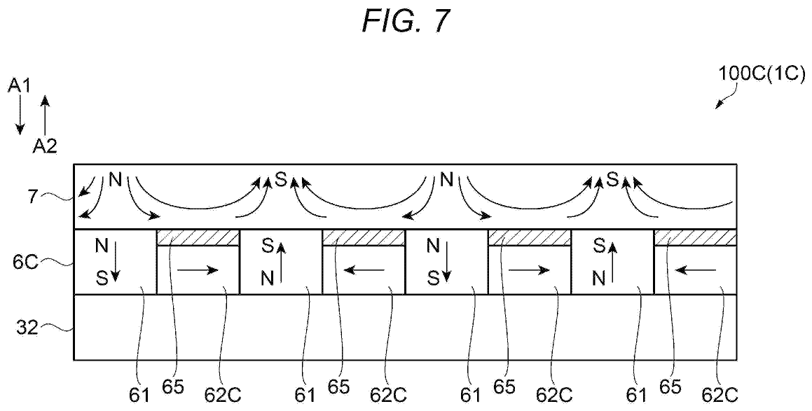

FIG. 7 is a sectional view showing a configuration of a magnet 100C of a rotary motor 1C according to a fourth embodiment.

The magnet 100C in the rotary motor 1C of the embodiment has the same configuration as the magnet 100B of the third embodiment. A difference is that, in the embodiment, soft magnetic portions 65 are placed in the spaces between sub-pole magnets 62C of a first magnet 6C and the second magnet 7.

As the soft magnetic portion 65, a soft magnetic material e.g. electromagnetic pure iron, ferro silicon, permalloy, electromagnetic stainless, or the like is used.

Also, according to the configuration, the magnetic flux density distribution at the boundaries between the first magnets 6C may be made smooth, the magnetic flux density distribution may be made closer to sinusoidal wave, and thereby, generation of cogging torque may be suppressed.

### 5. Fifth Embodiment

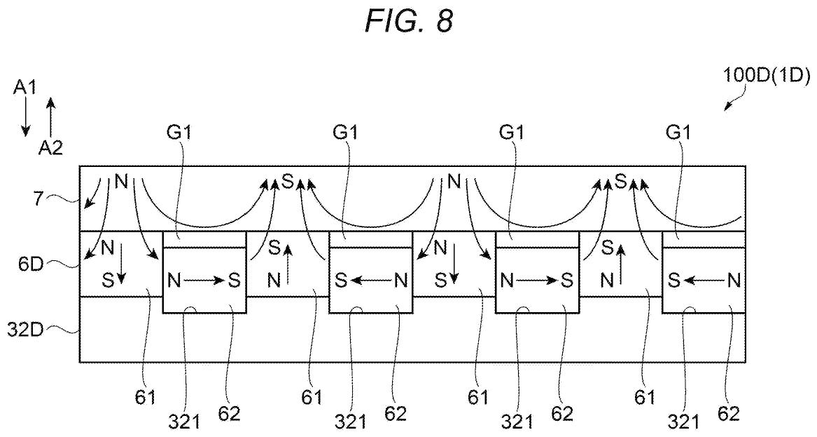

FIG. 8 is a sectional view showing a configuration of a magnet 100D of a rotary motor 1D according to a fifth embodiment.

The magnet 100D in the rotary motor 1D of the embodiment includes the first magnet 6 (a first magnet 6D in the embodiment) and the second magnet 71ike the magnet 100 of the first embodiment. Further, the first magnet 6D includes the main pole magnets 61 and the sub-pole magnets 62 like that in the first embodiment.

A difference in configuration from the first embodiment is that the sub-pole magnets 62 are placed in positions one level lower relative to the main pole magnets 61 in positions in the upward and downward directions of the main pole magnets 61. Accordingly, in a rotor frame 32D, the sub-pole magnets 62 are placed and fixed onto fixing surfaces 321 located one level lower than the positions where the main pole magnets 61 are placed. According to the configuration, the sub-pole magnets 62 and the second magnet 7 are separated with gaps G1 formed therebetween.

The sub-pole magnets 62 are placed in the positions one level lower relative to the main pole magnets 61, and the regions in which the adjacent main pole magnets 61 and the sub-pole magnets 62 are coupled may be different poles from each other. Thereby, the operation to weaken the magnetic forces with each other because of the same poles facing each other may be suppressed. In other words, demagnetization may be suppressed. Accordingly, the rotary motor 1D,even when the use environment temperature rises, harder to be demagnetized and stronger for a high temperature may be obtained.

### 6. Sixth Embodiment

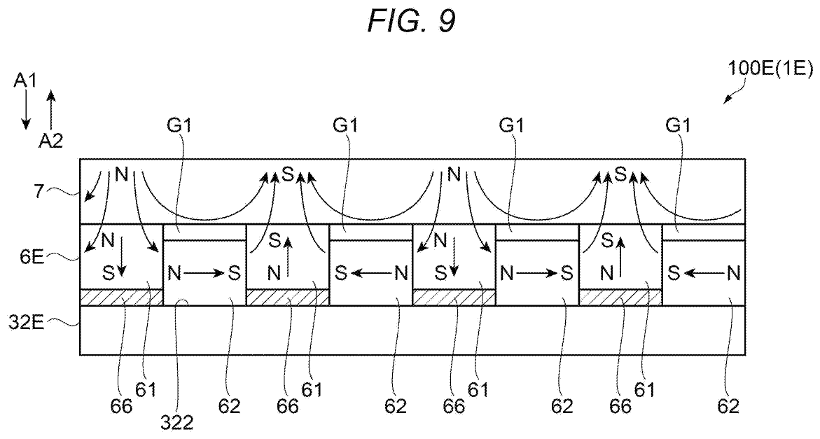

FIG. 9 is a sectional view showing a configuration of a magnet 100E of a rotary motor 1E according to a sixth embodiment.

The magnet 100E in the rotary motor 1E of the embodiment includes the first magnet 6D (a first magnet 6E in the embodiment) and the second magnet 7 1ike the magnet 100D of the fifth embodiment. Further, the first magnet 6E includes the main pole magnets 61 and the sub-pole magnets 62 like that in the fifth embodiment.

A difference from the fifth embodiment is, in the embodiment, in a rotor frame 32E, the sub-pole magnets 62 are placed on a fixing surface 322 and the main pole magnets 61 are placed in positions one level higher via soft magnetic portions 66.

According to the configuration, in addition to the placement of the different poles from each other in the regions in which the adjacent main pole magnets 61 and the sub-pole magnets 62 are couple, the soft magnetic portions 66 are placed for the level differences in the lower parts of the main pole magnets 61, and the magnetic flux flows more smoothly compared to that in the fifth embodiment. Thereby, demagnetization may be further suppressed.

### 7. Seventh Embodiment

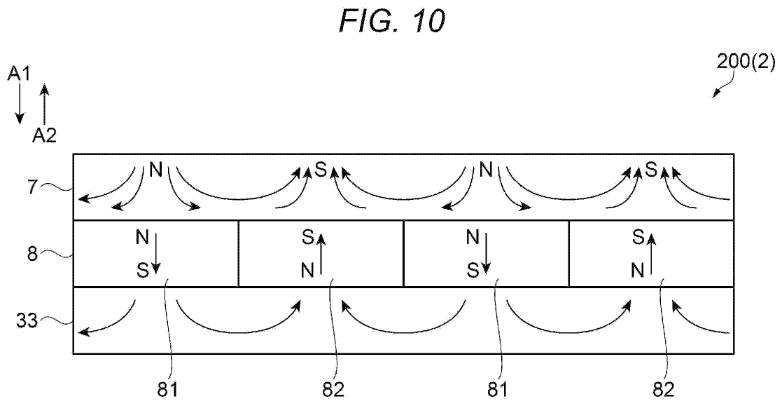

FIG. 10 is a sectional view showing a configuration of a magnet 200 of a rotary motor 2 according to a seventh embodiment.

The rotary motor 2 of the embodiment has substantially the same configuration as the rotary motor 1 of the first embodiment. A difference is in the configuration of the magnet 200. As shown in FIG. 10, the magnet 200 includes a first magnet 8 and the second magnet 7. The first magnet 8 includes a parallel anisotropic magnet and is arranged in the so-called NS array in which magnets 81, 82 having poles opposite to each other are alternatively arranged like the main pole magnets 61 of the first embodiment. The second magnet 7 is placed on an end surface of the first magnet 8 at the positive side in the first direction (upward direction A2) like that in the first embodiment. The second magnet 7 is formed in an annular shape with an isotropic magnet like that in the first embodiment.

Note that a rotor frame 33 of the embodiment corresponding to the rotor frame 32 of the first embodiment is formed as an auxiliary yoke and, specifically, formed using a soft magnetic material. The rotor frame 33 is formed as the auxiliary yoke, and thereby, the magnet 200 and the rotor frame 33 form a magnetic circuit and magnetic flux flows.

According to the embodiment, the following effects may be obtained.

In the rotary motor 2 of the embodiment, the magnet 200 has a plurality of the first magnets 8 having anisotropy and magnetized at least in the first direction (upward direction A2) and the second magnet 7 having isotropy and placed on the end surfaces of the first magnets 8 at the positive side in the first direction. The first magnets 8 forming the magnet 200 are arranged in the so-called NS array in which the magnets 81, 82 are alternatively arranged.

According to the configuration, the magnetic flux density may be improved by the plurality of first magnets 8 having anisotropy and arranged in the NS array less than the magnet 100 in the Halbach array of the first embodiment. In addition, the second magnet 7 having isotropy is placed on the end surfaces of the first magnets 8 at the positive side in the first direction, and thereby, the magnetic flux density distribution may be made smooth at the boundaries between the first magnets 8, the magnetic flux density distribution may be made closer to sinusoidal wave, and generation of cogging torque may be suppressed.

### 8. Eighth Embodiment

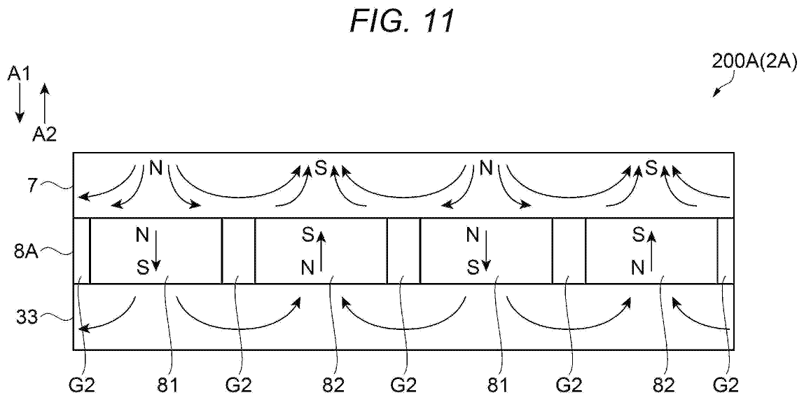

FIG. 11 is a sectional view showing a configuration of a magnet 200A of a rotary motor 2A according to an eighth embodiment.

The rotary motor 2A of the embodiment has substantially the same configuration as the rotary motor 2 of the seventh embodiment. A difference is in the way of arranging the magnet 200A. The other configurations are the same as those of the seventh embodiment. The same configurations have the same signs.

The magnet 200A of the embodiment is different in the way of arranging a first magnet 8A. Specifically, the first magnet 8A is arranged with gaps G2 provided between the adjacent magnets 81, 82.

According to the configuration, the adjacent magnets 81, 82 are separated and the magnetic flux density distribution at the boundaries between the first magnets 8A may be made smoother, the magnetic flux density distribution may be made closer to sinusoidal wave, and thereby, cogging torque may be suppressed.

When the effect of suppressing the cogging torque is lower in the rotary motor 2 of the seventh embodiment, the gaps G2 are provided between the adjacent magnets 81, 82 like those in the rotary motor 2A of the embodiment and the rotor frame 33 is used as the auxiliary yoke, and thereby, cogging torque may be suppressed without reduction of magnetic characteristics (torque etc.)

### 9. Ninth Embodiment

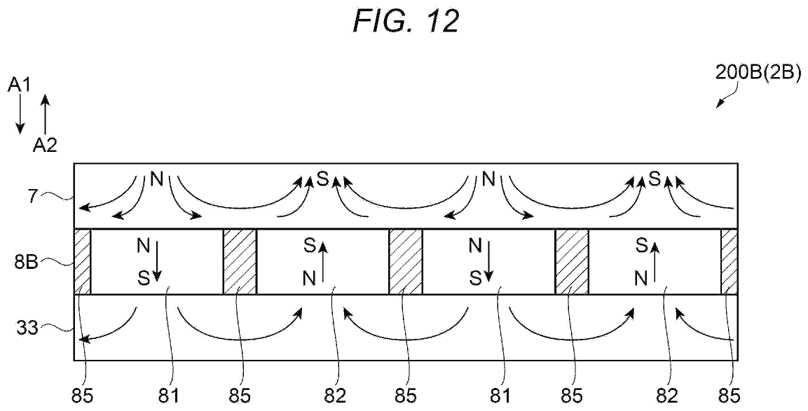

FIG. 12 is a sectional view showing a configuration of a magnet 200B of a rotary motor 2B according to a ninth embodiment.

The rotary motor 2B of the embodiment has substantially the same configuration as the rotary motor 2A of the eighth embodiment. A difference of the embodiment from the eighth embodiment is that auxiliary yokes 85 formed using a soft magnetic material are placed in regions corresponding to the gaps G2 in the eighth embodiment.

In the rotary motor 2B of the embodiment, the parts between the magnets 81 and the magnets 82 (corresponding to the gaps G2) are formed as the auxiliary yokes 85, and the magnet 200B, the auxiliary yokes 85, and the rotor frame 33 form a magnetic circuit. Accordingly, magnetic flux easily flows and the magnetic characteristics (torque etc.) are improved.

In the rotary motors 1, 1A to 1E, 2, 2A, 2B in the above described first embodiment to ninth embodiment, the configurations of the magnets 100, 100A to 100E, 200, 200A, 200B are applied to the axial gap motors. However, not limited to those, but the magnets may be applied to e.g. radial gap motors.

As below, embodiments of a rotary motor 10 of the application to the radial gap motor will be explained.

### 10. Tenth Embodiment

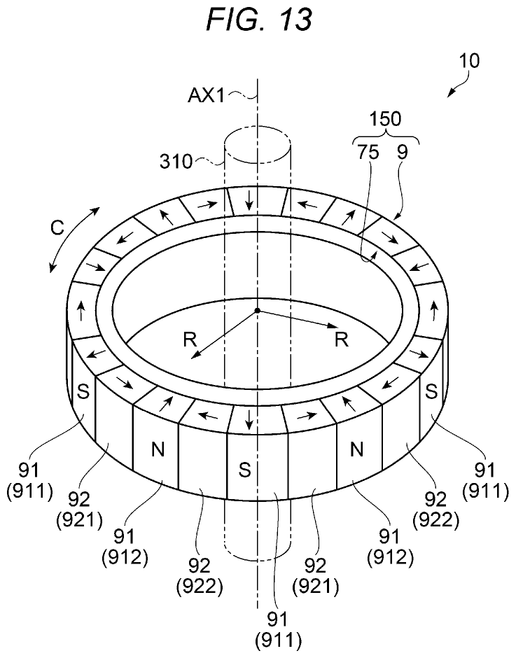

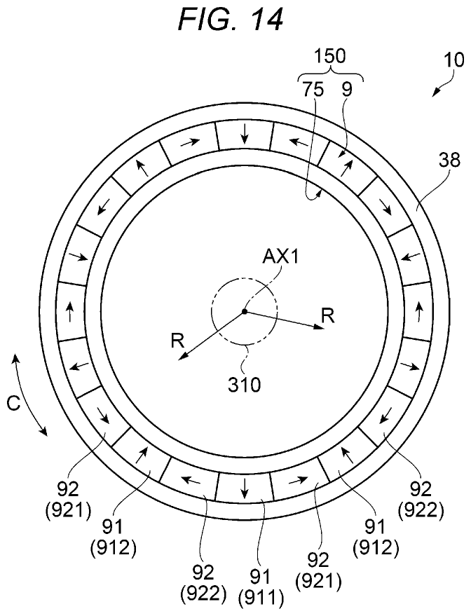

FIG. 13 is a schematic perspective view showing a configuration of a rotary motor 10 according to a tenth embodiment. In FIG. 13, the rotor frame 38 is omitted. FIG. 14 is a schematic plan view showing the configuration of the rotary motor 10.

The rotary motor 10 of the embodiment is formed as a radial gap motor. The radial gap motor is a motor having a gap between a magnet 150 and a coil (not shown) in the radial direction R of the rotation shaft 310, which will be described later.

As shown in FIGS. 13 and 14, the rotary motor 10 has a configuration including the cylindrical rotor frame 38 rotating around the rotation shaft 310 and the magnet 150 inside in the radial direction R of the rotor frame 38. The rotary motor 10 has the so-called outer-rotor configuration. Further, in the case of the embodiment, the coil is placed in a stator (not shown) having a predetermined gap inside of the magnet 150.

The magnet 150 has a first magnet 9 having anisotropy and a second magnet 75 having isotropy. Here, when a direction from the magnet 150 toward the coil is a first direction, the first direction corresponds to a direction toward a center axis AX1 (rotation shaft 310) in the radial direction R. The second magnet 75 is placed on an end surface of the first magnet 9 at the positive side in the first direction (the direction toward the center axis AX1). Note that the positive side corresponds to the coil side in the embodiment.

The first magnet 9 is integrally formed as a ring-shaped magnet. The second magnet 75 is also integrally formed as a ring-shaped magnet. The first magnet 9 and the second magnet 75 are molded using dies.

The first magnet 9 has main pole magnets 91 and sub-pole magnets 92. The first magnet 9 is formed in an annular shape by combination of the main pole magnets 91 and the sub-pole magnets 92 adjacent to the main pole magnets 91. Specifically, in the first magnet 9, the main pole magnets 91 and the sub-pole magnets 92 are alternately arranged at predetermined pitches along the circumferential directions C. The main pole magnets 91 and the sub-pole magnets 92 are arranged in the so-called Halbach array.

The first magnet 9 (main pole magnets 91 and sub-pole magnets 92) of the embodiment is an Nd—Fe—B sintered magnet and has anisotropy. The second magnet 75 of the embodiment is a ferrite sintered magnet. Further, the second magnet 75 has isotropy.

As shown in FIGS. 13 and 14, for the main pole magnets 91,magnets magnetized in two directions of the direction toward the center axis AX1 and the radial direction R are used. The main pole magnet 91 has a first main pole magnet 911 magnetized in the radial direction R and a second main pole magnet 912 magnetized in the direction toward the center axis AX1. For the sub-pole magnets 92, magnets magnetized in two directions of the circumferential directions C are used. The sub-pole magnet 92 has a first sub-pole magnet 921 magnetized toward the right side in the circumferential directions C and a second sub-pole magnet 922 magnetized toward the left side in the circumferential directions C. Note that the flows of magnetic flux by the magnet 150 and the coil are substantially the same as those of the first embodiment and the explanation thereof will be omitted.

According to the embodiment, the following effects may be obtained.

The rotary motor 10 of the embodiment is the radial gap motor, and the magnet 150 has the plurality of first magnets 9 having anisotropy and magnetized at least in the first direction (the direction toward the center axis AX1) and the second magnet 75 having isotropy and placed on the end surfaces of the first magnets 9 at the positive side in the first direction (the direction toward the center axis AX1). The rotary motor 10 has the outer-rotor configuration.

According to the configuration, the magnetic flux density may be improved by the plurality of first magnets 9 having anisotropy and magnetized at least in the first direction. In addition, the second magnet 75 having isotropy is placed on the end surfaces of the first magnets 9 at the positive side in the first direction, and thereby, the magnetic flux density distribution at the boundaries between the first magnets 9 may be made smooth, the magnetic flux density distribution may be made closer to sinusoidal wave, and generation of cogging torque may be suppressed.

The rotary motor 10 has the outer-rotor configuration and, when rotating, the rotor frame 38 may support the magnet 150 against the centrifugal force. Further, the outer-rotor rotary motor 10 has a larger diameter than that of an inner-rotor rotary motor, and the volume occupied by the magnets is larger and the magnetic force may be increased. Furthermore, because of the larger diameter, torque by the larger diameter may be generated.

### 11. Eleventh Embodiment

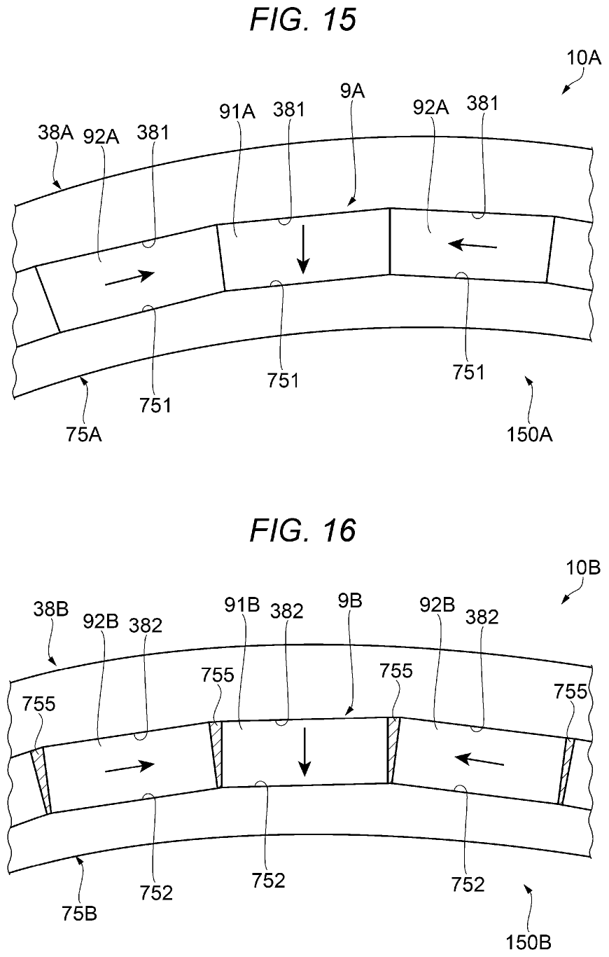

FIG. 15 is a schematic plan view showing a configuration of a rotary motor 10A according to an eleventh embodiment. Note that, in FIG. 15, a main part is enlarged and shown.

A difference of the embodiment from the tenth embodiment is in the shape of a first magnet 9A. A magnet 150A of the embodiment includes the first magnet 9A and a second magnet 75A. Further, the first magnet 9A includes main pole magnets 91A and sub-pole magnets 92A.

In the embodiment, as shown in FIG. 15, the main pole magnets 91A and the sub-pole magnets 92A forming the first magnet 9A have trapezoidal shapes in a plan view from a direction along the center axis AX1 (see FIGS. 13 and 14). Receiving surfaces 381 receiving the surfaces of the first magnets 9A having the trapezoidal shapes are provided on the inner surface of a rotor frame 38A. Further, receiving surfaces 751 receiving the surfaces of the first magnets 9A having the trapezoidal shapes are provided on the outer surface of the second magnet 75A like the receiving surfaces 381 of the rotor frame 38A.

According to the rotary motor 10A of the embodiment, the main pole magnets 91A and the sub-pole magnets 92A as the anisotropic first magnets 9A have the trapezoidal shapes in section. Thereby, the main pole magnets 91A and the sub-pole magnets 92A may be formed using flat plates and the manufacture may be made efficient.

### 12. Twelfth Embodiment

FIG. 16 is a schematic plan view showing a configuration of a rotary motor 10B according to a twelfth embodiment. Note that, in FIG. 16, a main part is enlarged and shown.

A difference of the embodiment from the eleventh embodiment is in the shape of a first magnet 9B. A magnet 150B of the embodiment includes the first magnet 9B and a second magnet 75B. Further, the first magnet 9B includes main pole magnets 91B and sub-pole magnets 92B.

In the embodiment, as shown in FIG. 16, the main pole magnets 91B and the sub-pole magnets 92B forming the first magnet 9B have rectangular shapes in the plan view from the direction along the center axis AX1 (see FIGS. 13 and 14). Receiving surfaces 382 receiving the surfaces of the first magnets 9B having the rectangular shapes are provided on the inner surface of a rotor frame 38B. Further, receiving surfaces 752 receiving the surfaces of the first magnets 9B having the rectangular shapes are provided on the outer surface of the second magnet 75B like the receiving surfaces 382 of the rotor frame 38B.

The second magnet 75B of the embodiment is formed by injection molding. As a method of the injection molding, in the embodiment, the anisotropic rectangular first magnets 9B placed on the rotor frame 38B are set in an injection molding machine and, then, a material to be the second magnet 75B is injected and molded.

As the material to be the second magnet 75B, in the embodiment, plastic magnet, the so-called pla-mag is used. The pla-mag is formed by mixing of metal powder (ferrite, neodymium, samarium cobalt, samarium cobalt iron nitrogen, or the like) as a raw material of a magnet and a plastic material. The second magnet 75B is molded by injection molding using the material. In this case, the molded second magnet 75B has isotropy.

Further, in the embodiment, the first magnets 9B having the rectangular shapes are used, and gaps are produced in the boundaries between the adjacent main pole magnets 91B and sub-pole magnets 92B. However, at the injection molding, the gaps are filled with the pla-mag and the same magnet 755 as the second magnet 75B is formed.

According to the rotary motor 10B of the embodiment, the main pole magnets 91B and the sub-pole magnets 92B as the anisotropic first magnets 9B have the rectangular shapes in section. Thereby, the main pole magnets 91B and the sub-pole magnets 92B may be formed using flat plates and the manufacture may be made efficient. Further, the second magnet 75B is formed by injection molding and may be manufactured more easily, and the gaps produced by the rectangular shapes of the first magnets 9B may be filled with the pla-mag by injection molding.

### 13. Thirteenth Embodiment

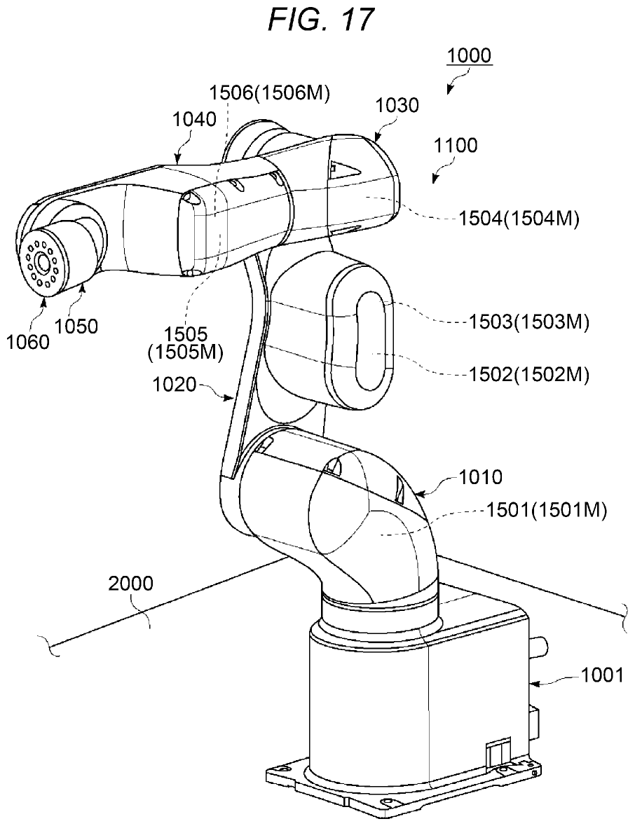

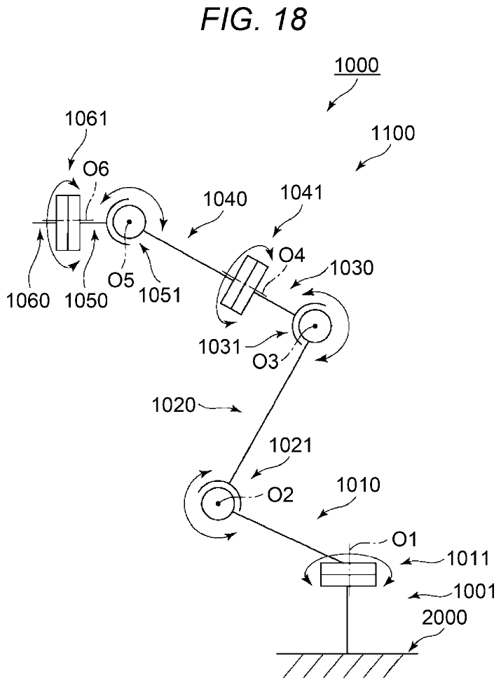

FIG. 17 is a perspective view showing a configuration of a robot 1000 according to a thirteenth embodiment. FIG. 18 shows a simplified configuration of the robot 1000.

As below, a configuration of the robot 1000 will be explained with reference to FIGS. 17 and 18.

As shown in FIG. 17, the robot 1000 is used for respective work of e.g. transport, assembly, inspection, etc. of various workpieces (objects). The robot 1000 has a base 1001, a robot arm 1100, and drive units 1501, 1502, 1503, 1504, 1505, 1506.

The base 1001 is mounted on a horizontal floor 2000. Note that the base 1001 may be mounted not on the floor 2000, but on a wall, a ceiling, a platform, or the like.

The robot arm 1100 includes a first arm 1010, a second arm 1020, a third arm 1030, a fourth arm 1040, a fifth arm 1050, and a sixth arm 1060. An end effector (not shown) may be detachably attached to the distal end of the sixth arm 1060, and a workpiece may be gripped by the end effector.

The end effector is not particularly limited to, but includes a hand gripping a workpiece and a suction head suctioning a workpiece. The workpiece gripped by the end effector is not particularly limited to, but includes e.g. an electronic component and an electronic apparatus. In the embodiment, the base 1001 side with reference to the sixth arm 1060 is referred to as “proximal end side” or “base side” and the sixth arm 1060 side with reference to the base 1001 is referred to as “distal end side”.

The robot 1000 is a single-arm six-axis vertical articulated robot in which the base 1001, the first arm 1010, the second arm 1020, the third arm 1030, the fourth arm 1040, the fifth arm 1050, and the sixth arm 1060 are sequentially coupled from the proximal end side toward the distal end side.

The lengths of the first arm 1010 to the sixth arm 1060 are respectively not particularly limited, but can be appropriately set. Note that the number of arms of the robot arm 1100 may be one to five, seven, or more. Alternatively, the robot 1000 may be a scalar robot or a dual-arm robot including two or more robot arms 1100.

As shown in FIG. 18, the base 1001 and the first arm 1010 are coupled via a joint 1011. The first arm 1010 is pivotable around a first pivot axis O1 parallel to a vertical axis as a pivot center relative to the base 1001. The first arm 1010 pivots by driving of a motor 1501M and the drive unit 1501 having a reducer (not shown). The motor 1501M generates a drive force for pivoting the first arm 1010.

The first arm 1010 and the second arm 1020 are coupled via a joint 1021. The second arm 1020 is pivotable around a second pivot axis O2 parallel to a horizontal plane as a pivot center relative to the first arm 1010. The second arm 1020 pivots by driving of a motor 1502M and the drive unit 1502 having a reducer (not shown). The motor 1502M generates a drive force for pivoting the second arm 1020.

The second arm 1020 and the third arm 1030 are coupled via a joint 1031. The third arm 1030 is pivotable around a third pivot axis O3 parallel to a horizontal plane as a pivot center relative to the second arm 1020. The third arm 1030 pivots by driving of a motor 1503M and the drive unit 1503 having a reducer (not shown). The motor 1503M generates a drive force for pivoting the third arm 1030.

The third arm 1030 and the fourth arm 1040 are coupled via a joint 1041. The fourth arm 1040 is pivotable around a fourth pivot axis O4 parallel to a center axis of the third arm 1030 as a pivot center relative to the third arm 1030. The fourth arm 1040pivots by driving of a motor 1504M and the drive unit 1504 having a reducer (not shown). The motor 1504M generates a drive force for pivoting the fourth arm 1040.

The fourth arm 1040 and the fifth arm 1050 are coupled via a joint 1051. The fifth arm 1050 is pivotable around a fifth pivot axis O5 orthogonal to a center axis of the fourth arm 1040 as a pivot center relative to the fourth arm 1040. The fifth arm 1050 pivots by driving of a motor 1505M and the drive unit 1505 having a reducer (not shown). The motor 1505M generates a drive force for pivoting the fifth arm 1050.

The fifth arm 1050 and the sixth arm 1060 are coupled via a joint 1061. The sixth arm 1060 is pivotable around a sixth pivot axis O6 parallel to a center axis in the distal end portion of the fifth arm 1050 as a pivot center relative to the fifth arm 1050. The sixth arm 1060 pivots by driving of a motor 1506M and the drive unit 1506 having a reducer (not shown). The sixth motor 1506M generates a drive force for pivoting the sixth arm 1060.

For at least one of these motors 1501M to 1506M, the rotary motors 1, 1A to 1E which are the axial gap motors in which the magnets are arranged in the Halbach arrays using the axial gap motors and the rotary motors 2, 2A, 2B which are the axial gap motors in which the magnets are arranged in the NS arrays in the above described embodiments are used.

Angle sensors (not shown) are provided in the drive units 1501 to 1506. These angle sensors include e.g. various encoders such as rotary encoders. The angle sensors detect pivot angles of the output shafts of the motors 1501M to 1506M or the reducers of the drive units 1501 to 1506.

The drive units 1501 to 1506 and the angle sensors are respectively electrically coupled to a robot control apparatus (not shown). The robot control apparatus independently controls the operations of the drive units 1501 to 1506.

According to the embodiment, the following effects may be obtained.

The robot 1000 of the embodiment includes the rotary motors 1, 1A to 1E, 2, 2A, 2B according to the above described embodiments. Further, the robot 1000 includes the robot arm 1100 corresponding to driven members driven by these rotary motors 1, 1A to 1E, 2, 2A, 2B.

In the robot 1000, the driven members are driven using the rotary motors 1, 1A to 1E, 2, 2A, 2B that suppress generation of cogging torque, and thereby, the robot arm 1100 may be smoothly moved and the robot 1000 may be downsized and the degree of freedom of design may be easily improved.

In the robot 1000 of the embodiment, for example, when the rotary motor 1 is used, the rotation shaft 300 may be made hollow because of being the axial gap motor, and wires may be passed through the rotation shaft 300 using the hollow. Particularly, when the driven member is the first arm 1010 as the arm at the proximal end side (or the arm at the base side) of the robot arm 1100, the number of wires is larger at the base side and wiring efficiency may be improved. In addition, higher output of the robot 1000 may be obtained compared to that in related art using the rotary motor 1.

### 14. Modified Example 1

In the first embodiment, an adhesive such as epoxy is used as the coupling material for the magnet 100. However, not limited to that, but e.g. mixture of powder of a soft magnetic material such as black iron oxide in the adhesive such as epoxy may be used as paste of the soft magnetic material. This applies to the other embodiments.

### 15. Modified Example 2

In the first embodiment, the unmagnetized isotropic magnet (unmagnetized second magnet 7) and the unmagnetized anisotropic magnet (unmagnetized first magnet 6) are magnetized at a time. However, not limited to that, but the unmagnetized isotropic magnet (unmagnetized second magnet 7) and the unmagnetized anisotropic magnet (unmagnetized first magnet 6) may be magnetized at separate steps.

### 16. Modified Example 3

In the rotary motor 10 of the tenth embodiment, the example in which the magnet 150 in the Halbach array is applied to the radial gap motor is explained. However, not limited to that, but a magnet in an NS array may be applied to the radial gap motor as a rotary motor. In this case, it is necessary for the rotor frame to have a function of a yoke. Further, when gaps or the like are produced between the adjacent magnets, the gaps may be treated as air gaps as they are, by filling with a resin mold, by filling with a magnet mold, by filling with a soft magnetic material, or the like.

### 17. Modified Example 4

In the rotary motor 10 of the tenth embodiment, the outer-rotor configuration is used. However, not limited to that, but an inner-rotor configuration may be employed as a rotary motor. In the inner-rotor configuration, the coil is placed outside of the magnet 150.

### 18. Modified Example 5

The rotary motors 10, 10A, 10B of the tenth embodiment to the twelfth embodiment use the parallel anisotropic magnets magnetized only in the single directions in the first magnets 9, 9A, 9B. However, not limited to that, but radial anisotropic magnets magnetized in the radial direction (e.g. the radial direction R) may be used.

### 19. Modified Example 6

In the rotary motor 10B of the twelfth embodiment, the second magnet 75B is formed by injection molding. However, not limited to that, but a second magnet integrally formed as a ring-shaped magnet may be used. In this case, gaps are produced at boundaries between the adjacent main pole magnets 91B and sub-pole magnets 92B. However, the gaps may be filled with paste of a soft magnetic material.

### 20. Modified Example 7

The rotary motors 1, 1A to 1E, 2, 2A, 2B in the first embodiment to the ninth embodiment are the motors employing the so-called 1-rotor 1-stator structures. However, not limited to that, but the motors may be applied to any structures such as 2-stator 1-rotor structures or 2-rotor 1-stator structures.

What is claimed is:

1. A rotary motor comprising:
a stator having a coil; and
a rotor placed apart from the stator and rotating around a rotation shaft, wherein
the rotor has a rotor frame coupled to the rotation shaft, and a magnet placed on the rotor frame,
when a direction from the magnet to the coils a first direction, the magnet has
a plurality of first magnets having anisotropy and magnetized at least in the first direction, and
a second magnet having isotropy and placed on end surfaces of the first magnets at a positive side in the first direction.

2. The rotary motor according to claim 1, wherein
the first magnet is arranged in an NS array.

3. The rotary motor according to claim 1, wherein
the first magnet is arranged in a Halbach array having main pole magnets and sub-pole magnets.

4. The rotary motor according to claim 3, wherein
the main pole magnets of the first magnet and the second magnet contact, and
the sub-pole magnets of the first magnet and the second magnet are separated.

5. The rotary motor according to claim 2, wherein
the second magnet is formed in an annular shape.

6. The rotary motor according to claim 3, wherein
the second magnet is formed in an annular shape.

7. The rotary motor according to claim 6, wherein
the second magnet includes a plurality of divided arc-shaped magnets.

8. The rotary motor according to claim 6, wherein
regions of the second magnet located in upper parts of the main pole magnets are magnetized along the first direction.

9. The rotary motor according to claim 7, wherein
end surfaces of the plurality of divided arc-shaped magnets are located in upper parts of the main pole magnets and magnetized along the first direction.

10. A robot comprising:
the rotary motor according to claim 1; and
a driven member driven by the rotary motor.

11. The robot according to claim 10, wherein
the rotary motor is an axial gap motor, and
the driven member is an arm at a base side.

12. A manufacturing method for a rotary motor having a stator having a coil, a rotor rotating around a rotation shaft, a rotor frame coupled to the rotation shaft, and a magnet having an anisotropic magnet and an isotropic magnet, the method comprising:
an anisotropic magnet placement step of placing the unmagnetized anisotropic magnet on the rotor frame;
when a direction from the anisotropic magnet to the coil is a first direction, an isotropic magnet placement step of placing the unmagnetized isotropic magnet on an end surface of the anisotropic magnet at a positive side in the first direction;
a magnetization step of magnetizing the placed unmagnetized anisotropic magnet and isotropic magnet; and
a stator placement step of placing the stator in the first direction with respect to the rotor in which the magnetized anisotropic magnet and isotropic magnet are placed.
